(19) United States
(12) Patent Application Publication
(10) Pub. No.: US 2017/0024689 A1
(43) Pub. Date: Jan. 26, 2017

(54) SYSTEM AND METHOD FOR TRACKING THE PRODUCTION AND SALE OF REGULATED AGRICULTURAL PRODUCTS

(71) Applicant: VIRIDIAN SCIENCES INC., Woodland, WA (US)

(72) Inventors: Justin Dufour, Woodland, WA (US); Garrett Hampton, Vancouver, WA (US)

(21) Appl. No.: 15/063,221

(22) Filed: Mar. 7, 2016

Related U.S. Application Data
(60) Provisional application No. 62/128,621, filed on Mar. 5, 2015.

(51) Int. Cl. G06Q 10/08; H04L 29/06

(52) U.S. Cl. CPC G06Q 10/087; H04L 63/062

(57) ABSTRACT

A system and method for tracking the production and sale of regulated agricultural products, such as Cannabis products. Secure tracking of the products is done with containers that have specific security keys and attributes known only to the inventory tracking system, which allows secure tracking though the different phases of production, retailing, and sale. Retailers can monitor the products available for purchase, and can allow the producers to provide detailed information on attributes of products that the regulated retailer may consider when deciding upon a purchase. The system can also give the retailer the ability to create a customized interface displaying real-time inventory attributes of the products at the retailer.

### CROSS-REFERENCE TO RELATED APPLICATION

This application claims the benefit of U.S. Provisional Patent Application No. 62/128,621, filed on Mar. 5, 2015, the entirety of which is hereby incorporated herein by this reference.

### BACKGROUND OF THE INVENTION

1. Field of the Invention

The present invention generally relates to inventory tracking systems. More specifically, the present invention relates to a system and method for tracking the production, transport and sale of a monitored and regulated agricultural product, such as Cannabis Sativa or opiate plants.

2. Description of the Related Art

There are extant inventory tracking systems that track the location and attributes about articles of inventory that are monitored. The articles can be any physical article, such as a manufactured good, packages, containers, raw materials, clothing, and the like. The tracking information can be any attribute of the article, such as the current location, intended location, and attributes about the nature of the article, such as quantity, weight, number and type of disparate items, perishability, and the like.

Some inventory system monitor regulated products from their creation, to storage, transport, and retail sale. For example, there are specialized systems that track pharmaceuticals from the creation of the underlying drug, to encapsulation in a pill, to aggregation of pills in containers, to storage and distribution at a pharmacy. Legal regulations can require very specific capabilities and security of the inventory monitoring system used in all phases of tracking of an article.

One problem that occurs is with articles that are regulated, or at least semi-regulated, that are naturally occurring and not initially manufactured such that their distribution system can be controlled by a single entity from production to final sale. For example, existing inventory systems are not well suited for products that are agriculturally cultivated and sold in a heavily regulated retail market, such as the sale of Cannabis Sativa, which is legal in many US states and regulated differently within each state. Inventory tracking of this type of regulated product is difficult to do with common inventory tracking systems because the existing system are typically only used for a specific phase of tracking, such as production, inventory, or retail sale. These existing tracking systems often do not interact with the inventory systems of the other phases of tracking. Further, current highly secure inventory tracking systems, such as those for pharmaceuticals, are incredibly cumbersome to use with lesser regulated articles, and are not well suited when manufacture of the tracked article is not part of the tracking process or different entities handle separate phases of the production to retail path of the regulated product.

### SUMMARY OF THE INVENTION

In one embodiment, the system and method is used to verify the security of regulated products in a tracked container by selectively keeping some accurate withheld from display to users looking at the products being tracked, and selectively putting inaccurate information about the tracked products to the users that are reported back to the system. In such manner, a discrepancy in the attributes the tracked containers with their regulated products, such as an improper or unlikely weight, number, product variation, and the like, will indicate that the container and regulated product may have been tampered with.

The system receives inventory information on one or more tracked containers of a regulated product at the one or more inventory tracking servers, where the containers have at least content attribute information, such as what the regulate product is, weight, quantity, and the like, and an associated security key. The security key can be a bar code, numerical code, hash function based upon other container attributes, and the like.

The system stores the accurate content attribute information for each tracked container, and then associates a security key with a specific tracked container. The system can then provide an application programming interface (API) to one or more computer devices that each include a display such that the API can selectively display the location information and a container content attribute information for the one or more tracked containers, and the displayed container content attribute information can selectively be inaccurate as it appears to the user. When the system receives inventory update information as sent by user at remote location about the tracked container, including, at least location information for the container, the displayed container content attribute information, and the security key of the tracked container, the system can verify the security key for the specific tracked container.

The verification of the security of a tracked container occurs from comparison of displayed container content attribute information received with the accurate content attribute information and, if the accurate container content attribute information does not match, comparison with the selectively inaccurate displayed container content attribute information.

In another embodiment, the present invention is a system and method for cannabis farmers, producers, processors of cannabis product to upload their available inventory of agricultural products, such as Cannabis, via an API over the internet using a computer such that the inventory is available to retailers to purchase. The farmers and/or producers can receive online notifications of potential purchase requests, sample requests, or quote requests from Cannabis retailers.

In another embodiment, the present invention includes a system and method for Cannabis retailers and Cannabis dispensaries to search for cannabis products over a collection of different cannabis farmers, producers, and processors. The retailers and dispensaries can search for cannabis products for a specific cannabis farmer, producer, or processor, and can filter cannabis products by a specific attribute. The system also allows the retailer or dispensary to request a product sample, quote, or purchase from a specific cannabis farmer, cannabis producer, or cannabis processor. The system also permits the retailer or dispensary to set an alert for cannabis product given a certain set of user defined attributes, like price, quantity, product name, or test results.

In a further embodiment, the present invention includes user interfaces that are customized for display to a user having a small factor computer that has a display screen. There can be software running on the small form factor computer that connects to a network and displays a web application through a browser.

In a further embodiment, the present invention includes a web application that displays real-time inventory information of Cannabis products. As products are sold out in a store, they are removed from the display screen. The product identifiers can be color coded based on currently available inventory, and an item image of the actual product can be displayed. The system further allows users to configure the functionality of the display screen as to what types or product groups are shown, and gives the operator of the system the ability to place advertising streams within the displayed inventory data.

### BRIEF DESCRIPTION OF THE DRAWINGS

FIG. 1 is an exemplary embodiment of the system for tracking the regulated product as implemented across a network, such as the Internet.

FIG. 2 is a representative diagram illustrating the inventory tracking system tracking a container of a regulated product as it travels from farm to production to retail locations.

FIG. 3 is a screenshot of an interface that is produced by the inventory tracking system for available inventory of Cannabis products for purchase.

FIG. 4 is a screenshot of an interface produced by the inventory tracking system for a retailer selling Cannabis products and conveying specific information on each product.

FIG. 5 is a flowchart that illustrates one embodiment of the process used by the inventory tracking system to intake attribute information for each container of regulated product and selectively vary attribute display information to verify the security of the regulated product contents of the container.

### DETAILED DESCRIPTION

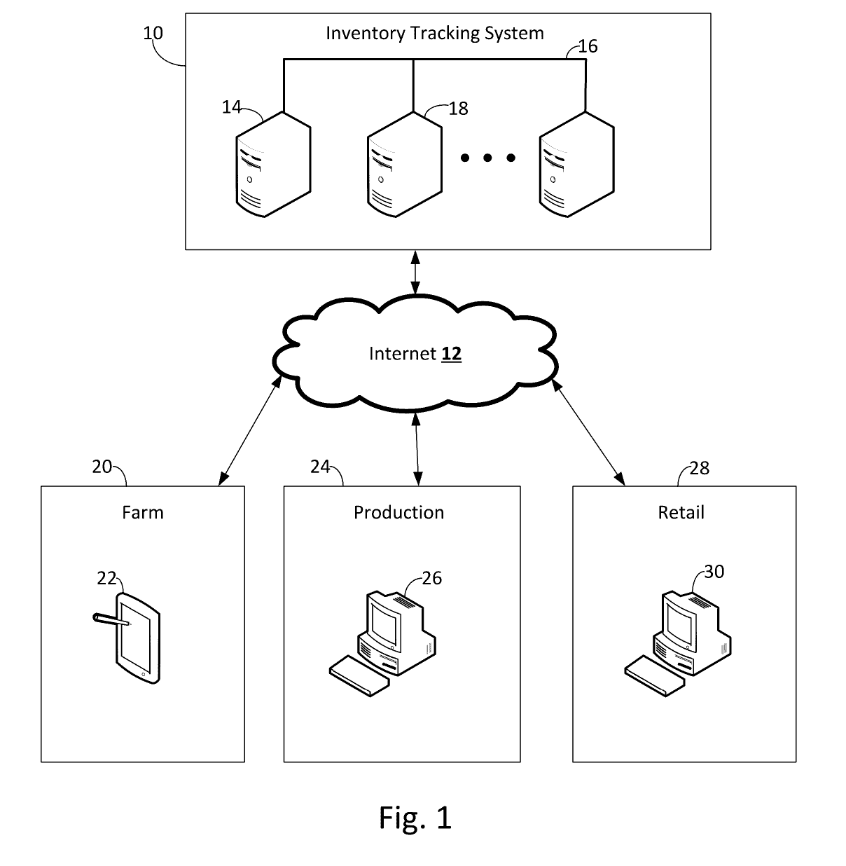

Referring now to the drawings and figures therein which describe the present system and methods in more detail, FIG. 1 is an exemplary embodiment of the system 10 for tracking the agricultural product as implemented across a network, such as the Internet 12. The inventory tracking system 10 can include one or more computer components 14, such as servers, data storage, raid and logic arrays, and other computer components and assets on an internal network 16, or an external network, such as a virtual private network on the Internet 12. As shown here, the system 10 interacts with a farm 16, production 20 facility, and retailer 24.

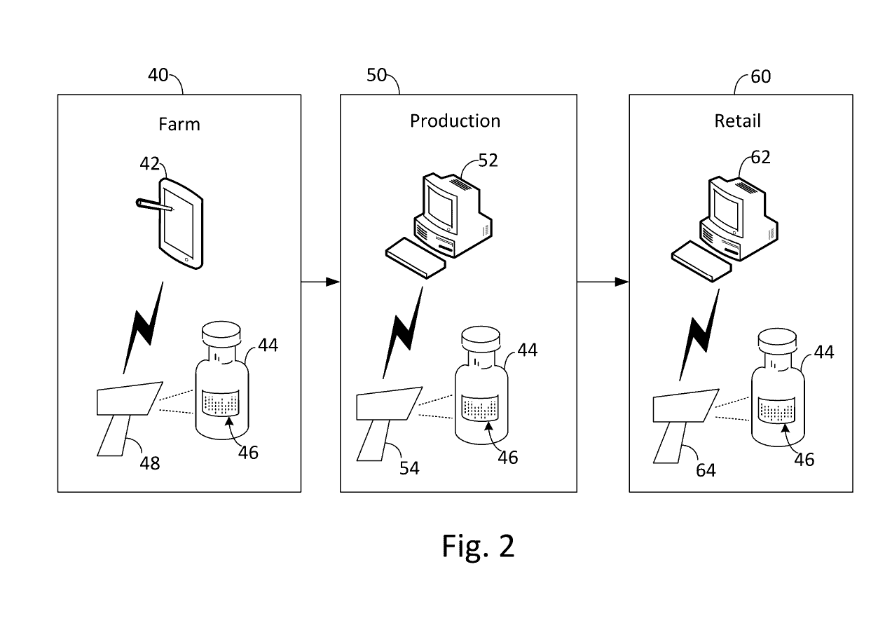

The inventory tracking system 10 includes at least one inventory tracking server 14 that receives inventory information on one or more tracked containers of a regulated product (such as container 44 in FIG. 2. As described further herein, each container 44 has at least content attribute information, such as the identity of the product contained, the weight, quantity, color, or any other discernable physical attribute. The inventory tracking system 10 associates a security key with each container 44 and stores the content attribute information for each tracked container 44, and in one embodiment, can store the security key at a security key database 18.

As further shown in the representative diagram of FIG. 2, the inventory tracking system 10 receives inventory update information about the tracked container 44 from the various facilities, such as the farm 40, production facility 50, and retail location 60. In this embodiment, a scanner 48,54, 64 will scan a barcode 46 of the tracked container 44 at each location, and send the updated information, including, at least location information for the container 44 (i.e., where it is located, such as at farm 40), and give updated container content attribute information, such as what was placed into or taken out of the container 44, the subsequent changes to the attributes of the regulated product in the container 44, such as changes to the weight, number, composition, or other physical attribute of the container. The security key for the tracked container 44 is also taken (such as scanned or input) at the physical location of the container 44.

The embodiment of FIG. 2 uses embedded codes on the exterior of the container 44, such as bar code 46. In each location, the bar code 46 is scanned and information sent to the inventory tracking system 10. To illustrate the tracking of a container 44 to verify security, at the farm 40, the scanner 48 will scan the bar code 46 of the container and transmits the information to the farm tablet computer 42 for upload to the inventory tracking system 10. For example, the farm 40 can input into the inventory tracking system 10 that the container 44 has 5g of regulated product (e.g., Cannabis extract) within it. The inventory tracking system 10 can then note to any inquiring user what is contained within container 44 and the salient attributes.

Then when the container 44 is moved to the producer at production facility 50, the scanner 54 can scan the bar code 46 of the container 44, thereby getting the security key and relaying the key to the production computer 52. The producer can then weigh the contents of the container 44 and report that 5 g of regulated product is contained therein. This updated information is then relayed to the inventory tracking system 10, and can be verified as to the security key and content information to ensure that the container 44 has not been tampered with in transit. However, the inventory tracking system 10 can also purposely alter attribute information about the contents of the container 44 to ensure that persons handling the container cannot purposely mislead the inventory tracking system 10 and remove or alter contents from the container 44.

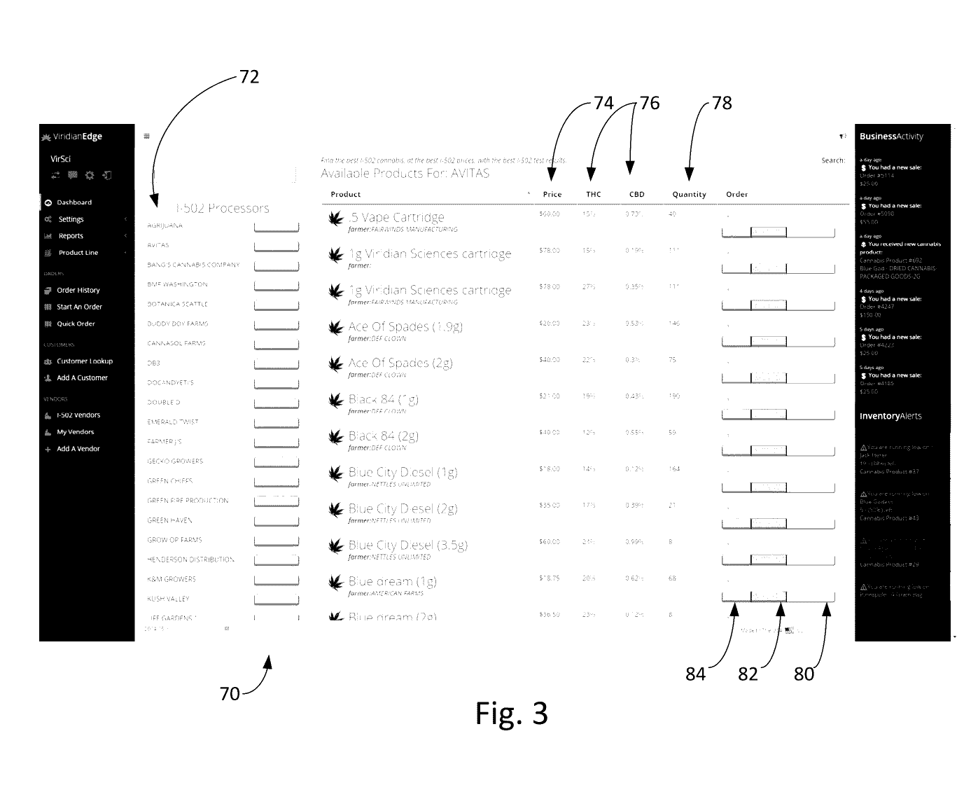

For example, the inventory tracking system 10 can purposely list the weight of the contents of the container 44 as a greater or lesser number than is actually present. In such manner, the inventory tracking system 10 will know what the correct weight is and it will not be reflected in the display screens, such as that shown in FIG. 3. When the weight is then scanned at the production facility 50, the true weight will be reported, which is not initially displayed to the user and thus, the user cannot purposely manipulate the content attribute information, such as weight of the contents. Through this subtle and occasional manipulation of the regulated content attribute information, the inventory tracking system 10 can determine if alterations being made to the container 44 because a person cannot intentionally manipulate the inventory tracking data to hide tampering, theft, etc.

The security key can be encoded on the container 44, such as the bar code 46, or any other optical tracking technology such as 2D and 3D bar codes. The security key can also be integrated with a specific tracked container 44, such as an RFID tag, radio tag, near-field communication chip, or other radio communication device. The security key can thus be steganographic, visible, invisible, encrypted, and/or a hash function of other attributes of the container 44. For example, the security key of the tracked container 44 can generated from a first numerical key created for the tracked container 44, such as a large prime number in a paired-key hash as is well known the art, and a mathematical function with the accurate container content attribute information, such as the weight of the contents. Thus, the hash number will be mathematically verifiable by division with the stored key at the security server 18.

Referring again to FIG. 2, the tracked container 44 can then be sent from the production facility 50 to the retail location 60, and thus the retail location 60 can then scan the container 44 with scanner 64 and upload the new information to the retail computer 62 for relay to the inventory tracking system 10. Purposely altered content attribute information can be used again in the transfer of the container 44 between the production facility 50 and retail location 60, and the same or different attributes can be purposely altered.

In the embodiment of FIG. 1, there is a security server 18 within the inventory tracking system 10 that receives the security key for the specific tracked container 44 from the inventory tracking server itself 14. The security server 18 then verifies the security key information for a tracked container 44 in this embodiment, which can be done in parallel with verification of the content attributes. Alternately, the inventory tracker server 14 can verify the security of a tracked container from comparison of received location information, updated content attribute information, and verification of the security key of the tracked container 44. It should be apparent that the functions of the inventory tracking system 10 can be on one computer device, be spread among many computer devices, or performed by cloud computing services.

In the embodiment of FIG. 2, the data intake system used to remotely obtain the location information, updated container content attribute information, and the security key from the tracked container 44 is shown at the resident computers 42,52,62 at the farm 40, production 50, and retail 60 locations, along with their respective scanners 48,54,64. Thus, these data intake systems can be fully integrated with the inventory tracking system 10 and be applications executing on the computers 42,52,62. Alternately, each computer system at the farm 40, production 50, and retail 60 locations can be fully independent from the inventory tracking system 10 and simply provide data thereto in a compatible format such that the inventory tracking system 10 can easily intake the data for recordation and tracking.

Furthermore, in FIG. 2, the container 44 is shown as a labeled bottle. The tracked container 44 can be any type of bag, bottle, or enclosure of any hard or soft material. The size of the tracked container 44 can also be varied small to large, and can change through movement between locations, such having the regulated contents divided into smaller containers from the production facility 50 to the retail location 60.

FIG. 3 is an illustration of one embodiment of a screenshot 70 of an application programming interface (API) that is produced by the inventory tracking system 10 for available inventory of Cannabis products for purchase This embodiment 10 allows Cannabis farmers, producers, processors of Cannabis product, such as farm 20 and production 24 facility, to upload their available inventory via an API over the internet 12 using a computer, such as a tablet 22 at the farm 20 or a computer 26 at the production facility 24. The available inventory can be uploaded through an online hosted web application from the inventory tracking system 10 to produce a list of available Cannabis products such as those shown in the screen shot 70 of FIG. 3. Through the inventory tracking system 10, the farm 20 can receive notifications of potential purchase requests, sample requests, or quote requests from Cannabis retailers (retail location 28), and allow the Cannabis retailers and Cannabis dispensaries, such as retail location 28, to search for cannabis products over a collection of different cannabis farmers, producers, or processors. The inventory tracking system 10 can thus provide for secure tracking of the regulated Cannabis inventory though the various locations and actions of the production and sales process as is further described herein.

As shown in FIG. 3, a screenshot 70 is displayed at retail computer 30. Thus, through the API shown in screenshot 70 the retailer can search for cannabis products for a specific cannabis farmer, producer, processor, such as processor list 72. Other attributes can be filtered, such as price 74, test results 76, or quantity 78. The system 10 also allows the retailer to request a product sample (button 80), request a product quote (button 82), and request to purchase a product (button 84) from a specific cannabis farmer, cannabis producer, or cannabis processor. The retailer can also set an alert to receive an email for specific cannabis product given a certain set of user defined filters, such as the price, quantity, product name, or test results.

Thus, in one embodiment, the inventory tracking server 10 can have the API, such as screenshot 70 selectively display the location information (e.g., Farmer name) and updated container content attribute information, e.g., quantity, for the one or more potentially tracked containers. Thus, the user at the API with screenshot 70, can selectively search the container content attribute information and request an action be taken with a specific tracked container 44.

For security, the inventory tracking system 10 can purposely varying the product attribute, such as THC, CBD, (testing results 76) and quantity 78 such that the retailer will believe the what was sent is in error, when in fact, the error will be the correct reporting of what was received. The purposeful error can be slight enough to not affect the material nature of the purchase. For example, an intentional lesser quality can be sent with an immediate follow up ship already sent such that when the retailer or producer receives the first shipment, the follow up shipment is already in route. Alternately, an erroneous ship can purposely be sent with the incorrect item entirely such that local testing at the producer detects the error and reports it. Through this purposeful introduction of occasional errors, it is very difficult to manipulate inventory data within the inventory tracking system 10 to hide theft or tampering.

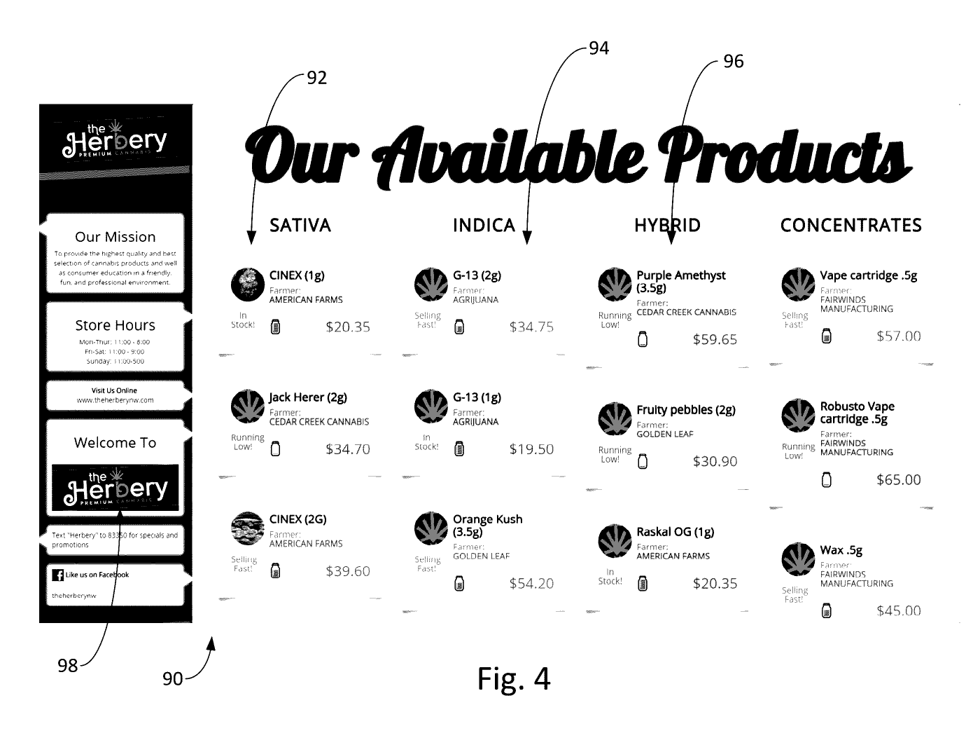

FIG. 4 is a screenshot 90 of an interface produced by the inventory tracking system 10 for a retailer selling Cannabis products and conveying specific information on each product. In this embodiment, the inventory tracking system 10 can also provide an Internet API that displays real-time inventory information of Cannabis products for a retail location 28. Often in the retail establishment, the point of sale will have a small factor computer that is connected to a display screen, typically a flat panel TV, such as retail computer 26. In one embodiment, the computer 30 will have software running thereupon that connects to a network and ultimately to inventory tracking system 10 and displays the API through a browser. As products are sold out in a retail store, they are removed from the display screen. In one embodiment, products are color coded based on currently available inventory. Thus, green backgrounds for the product (item 92) means an good supply, yellow backgrounds means supplies are dwindling (item 94), and red backgrounds means the items are almost sold out (item 96). In this embodiment, the screenshot 90 also displays each item's image, but this is not necessary in all embodiments.

In this embodiment, retail users are able to configure the functionality of the display screen as to what types or item groups are shown. Furthermore, the inventory tracking system 10 can place an advertisement (ad 98) into the screenshot 90 on the display. This allows other entities in the production to retail chain to advertise to the retailer, which can be paid advertising to the user of the inventory tracking system 10.

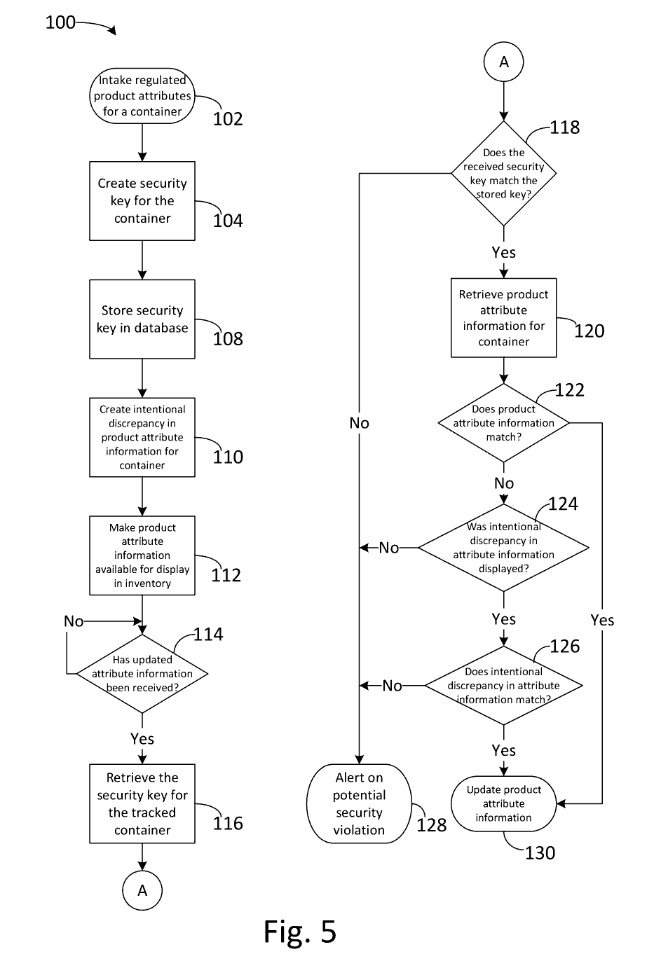

FIG. 5 is a flowchart that illustrates one embodiment of the process 100 used by the inventory tracking system 10 to intake attribute information for each container 44 of regulated product and selectively vary attribute display information to verify the security of the regulated product contents of the container 44. The process starts with the intake of the attributes of the regulated product in the container 44 as shown at start process 102. Then the security key for the container 44 is created, as shown at step 104, and the security key is stored in the security database 18, as shown at step 108. A selective discrepancy in the displayed data, such as altering the THC, CBC 76 and/or quantity 78 for several regulated products is created and then displayed in the screenshot 70 to the user of the inventory tracking system 10, as shown in FIG. 3. The inventory tracking system 10 then makes the product attribute information, including any intentional discrepancy, available for display, as shown in step 112, which can be screenshot 70 in FIG. 3.

A determination is then made as to whether any updated production attribute information has been received within the inventory tracking system 10, as shown at decision 114. This would occur when the product information and tracking container 44 information are obtained, such as scanning the tracking container 44 at the production facility 50 in FIG. 2. If no updated product information has been received, the process can enter a wait state at decision 114, as shown. Alternately, the process could be embodied do end and restart at start 102 upon the information being received once again at an intake.

If the updated product attribute information has been received at decision 114, then the security key is retrieve for that specific tracked container 44, as shown at step 116. This step can be retrieving the security key from a security key database 18 at the inventory tracking system 10. Once the known security key is retrieved at step 116, then a determination is made as to whether the security key received for the tracked container 44 matches the stored security key as retrieved from the security key database 118. If the security keys do not match at decision 118, then an alert is generated indicating a potential security violation may exist and the process ends, as shown at terminator 128.

Otherwise, if the security keys match at decision 118, then the regulate product attribute information for the tracked container 44 is retrieved within the inventory tracking system 10, as shown at step 120. After the regulated product attribute information is retrieved, then a determination is made as to whether the product attribute information received from the update matches the stored product attribute information, as shown at decision 122. If the production attribute information matches at decision 122 then the new production information from the update (if any) is allowed to proceed and the process terminates at terminator 130.

If the received product attribute information does not match at decision 122, then a determination is made as to whether there was an intentional discrepancy was introduced into displayed information, such as potentially having been done at step 110, as shown at decision 124. If no intentional discrepancy had been introduced in the displayed product attribute information at decision 124, then it is clear there is an attribute discrepancy and an alert is generated about the potential security violation and the process ends at terminator 128.

Otherwise, if there was an intentional discrepancy introduced into the product attribute information at decision 124, then a further determination is made as to whether the intentional discrepancy information matches the received product attribute information that is known to be incorrect, as shown at decision 126. If the product attribute information does not match at decision 126, then an alert is generated on the potential security violation and the process terminates at terminator 128. Otherwise, if the received product attribute information matches the intentional discrepancy at decision 126, then the process is allowed to update with any new product update information (such as location, quantity, etc.) and the process ends at terminator 130.

The above embodiments are shown as examples are not intended to limit the specific functionality the inventory tracking system 10 may have in each configuration. The inventory tracking system 10 can accordingly be comprised of individual computer components that can contain only one, or up to all, of the attributes described herein.

What is claimed is:

1. A system for securely tracking the inventory of a regulated product, comprising:
at least one inventory tracking server that:
receives inventory information on one or more tracked containers of a regulated product, the containers having at least content attribute information and an associated security key;
stores the content attribute information for each tracked container;
associates a security key with a specific tracked container;
receives inventory update information about the tracked container, including, at least location information for the container, updated container content attribute information, and the security key of the tracked container; and
at least one security server that:
receives the security key for the specific tracked container from the inventory tracking server; and
verifies the security key information for a tracked container,
wherein the inventory tracker server verifies the security of a tracked container from comparison of received location information, updated content attribute information, and verification of the security key of the tracked container with the security server.

2. The system of claim 1, further comprising a data intake system to remotely obtain the location information, updated container content attribute information, and the security key from the tracked container.

3. The system of claim 1, wherein the inventory tracking server further provides an application programming interface (API) to one or more computer devices that each include a display such that the API can selectively display the location information and updated container content attribute information for the one or more tracked containers.

4. The system of claim 3, wherein the API is further configured to allow a user at the one or more computer devices to selectively search the container content attribute information and request an action be taken with a specific tracked container.

5. The system of claim 3, wherein the API is further configured to allow a user at the one or more compute devices to selectively set an alert for a predefined change in container content attribute information.

6. The system of claim 4, wherein the inventory tracking server is further configured to provide one or more advertising streams within the displayed inventory data.

7. The system of claim 1, wherein the security key is integrated with a specific tracked container.

8. The system of claim 7, wherein the security key is encoded on the specific tracked container.

9. A method for securely tracking the inventory of a regulated product at one or more inventory tracking servers, comprising the steps of:
receiving inventory information on one or more tracked containers of a regulated product at the one or more inventory tracking servers, the containers having at least content attribute information and an associated security key;
storing the content attribute information for each tracked container;
associating a security key with a specific tracked container;
receiving inventory update information about the tracked container, including, at least location information for the container, updated container content attribute information, and the security key of the tracked container;
verifying the security key for the specific tracked container; and
verifying the security of a tracked container from comparison of received location information, updated content attribute information, and verified security key.

10. The method of claim 9, further comprising the step of obtaining, at the location of the tracked container, the location information, updated container content attribute information, and the security key from the tracked container.

11. The method of claim 9, further comprising the step of providing an application programming interface (API) to one or more computer devices that each include a display such that the API can selectively display the location information and updated container content attribute information for the one or more tracked containers.

12. The method of claim 11, further comprising the step of allowing a user at the one or more computer devices to selectively search the container content attribute information and request an action be taken with a specific tracked container.

13. The method of claim 11, further comprising the step of allowing a user at the one or more compute devices to selectively set an alert for a predefined change in container content attribute information.

14. The method of claim 12, further comprising the step of providing one or more advertising streams within the displayed inventory data.

15. The method of claim 9, further comprising the step of integrating a security key with a specific tracked container.

16. The method of claim 9, further comprising the step of encoding the security key on the specific tracked container.

17. A method for verifying the security of regulated products in a tracked container, comprising the steps of:
receiving inventory information on one or more tracked containers of a regulated product at the one or more inventory tracking servers, the containers having at least content attribute information and an associated security key;
storing the accurate content attribute information for each tracked container;
associating a security key with a specific tracked container;
providing an application programming interface (API) to one or more computer devices that each include a display such that the API can selectively display the location information and a container content attribute information for the one or more tracked containers, the displayed container content attribute information selectively being inaccurate to the stored accurate content attribute information;
receiving, as sent by user at remote location, inventory update information about the tracked container, including, at least location information for the container, the displayed container content attribute information, and the security key of the tracked container;
verifying the security key for the specific tracked container; and
verifying the security of a tracked container from comparison of displayed container content attribute information received with the accurate content attribute information and, if the accurate container content attribute information does not match, comparison with the selectively inaccurate displayed container content attribute information.

18. The method of claim 17, further comprising the step of, after verifying the security of a tracked container, displaying the accurate container content attribute information for the one or more tracked containers at the API.

19. The method of claim 17, further comprising the step of, after verifying the security of a tracked container upon received selectively inaccurate displayed container content attribute information:
determining the accurate container content attribute information;
storing the accurate container content attribute information; and
displaying a further selectively inaccurate container content attribute information for the one or more tracked containers at the API.

20. The method of claim 17, wherein the container content attribute information is the weight of the regulated contents of the tracked container.

21. The method of claim 17, wherein the container content attribute information is the number of the regulated contents of the tracked container.

22. The method of claim 17, wherein the security key of the tracked container is generated from a first numerical key created for the tracked container and a mathematical function with the accurate container content attribute information.
